(19) United States
(12) Patent Application Publication
(10) Pub. No.: US 2026/0023027 A1
(43) Pub. Date: Jan. 22, 2026

(54) DEVICE ANALYSIS METHOD AND ANALYSIS APPARATUS THEREFOR

(71) Applicant: Dongguk University Industry-Academic Coorporation Foundation, Seoul (KR)

(72) Inventors: Kwunbum CHUNG, Seoul (KR); Kwangsik JEONG, Seoul (KR); Hyunsuk KIM, Seoul (KR)

(73) Assignee: Dongguk University Industry-Academic Cooperation Foundation, Seoul (KR)

(21) Appl. No.: 18/910,595

(22) Filed: Oct. 9, 2024

(30) Foreign Application Priority Data
Jul. 17, 2024 (KR) 10-2024-0094407

(51) Int. Cl. G01N 21/88; G01N 21/95

(52) U.S. Cl. CPC G01N 21/8851; G01N 21/9501; G01N 2021/8883

(57) ABSTRACT

A device analysis method includes manufacturing a device, supplying a first light signal to the device at a plurality of incident angles or a plurality of azimuth angles, detecting a second light signal reflected from the device, determining whether the device is normal or defective by analyzing the second light signal, and when the device is a defective device, performing defect modeling on the defective device, wherein the performing of the defect modeling includes calculating a distribution of defects.

### CROSS-REFERENCE TO RELATED APPLICATION

This application is based on and claims priority under 35 U.S.C. § 119 to Korean Patent Application No. 10-2024-0094407, filed on Jul. 17, 2024, in the Korean Intellectual Property Office, the disclosure of which is incorporated by reference herein in its entirety.

### BACKGROUND

### 1. Field

The disclosure relates to a device analysis method and an analysis apparatus therefor. More particularly, the disclosure relates to a device analysis method using a non-linear light signal and an analysis apparatus therefor. This research was supported by the Samsung Future Technology Promotion Project (Project No.: SRFC-TC2103-02).

### 2. Description of the Related Art

In non-linear optics, light beam input(s) are output as the sum, difference, or harmonic frequencies of the light beam input(s). Second harmonic generation (SHG) is a non-linear effect in which light is emitted with twice the frequency of an incident light beam. This process may be considered as combining two photons of energy E to produce a single photon 2E of incident radiation (i.e., to produce light with twice (2w) the frequency or half the wavelength). Such an effect may be generalized to photon combinations of different energies corresponding to different frequencies.

Without being bound by any particular theory, an SHG process does not occur in materials that exhibit the center of symmetry (i.e., inversion or centrosymmetric materials), including amorphous materials, or in bulks. In the case of such materials, an SHG process may be detected only on surfaces and/or interfaces where the inversion symmetry of bulk materials is broken. Therefore, the SHG process sensitively provides information about surface and interface characteristics.

### SUMMARY

Provided are a quick and accurate device analysis method and an analysis apparatus therefor.

In addition, the technical objectives to be achieved by the disclosure are not limited to the above objective, and other objectives that are not mentioned herein will be clearly understood from the following description by those of ordinary skill in the art.

Additional aspects will be set forth in part in the description which follows and, in part, will be apparent from the description, or may be learned by practice of the presented embodiments of the disclosure.

According to an aspect of the disclosure, a device analysis method includes manufacturing a device, supplying a first light signal to the device at a plurality of incident angles or a plurality of azimuth angles, detecting a second light signal reflected from the device, determining whether the device is normal or defective by analyzing the second light signal, and when the device is a defective device, performing defect modeling on the defective device, wherein the performing of the defect modeling includes calculating a distribution of defects.

The performing of the defect modeling may be based on a shape of the device.

The performing of the defect modeling may be based on an intensity of the second light signal according to the plurality of incident angles or the plurality of azimuth angles.

A cross section of the device may include a bottom portion extending in a horizontal direction and a side surface portion extending in a vertical direction perpendicular to the horizontal direction.

The performing of the defect modeling may include separating the detected second light signal into a bottom portion component and a side surface portion component.

A cross section of the device may have a curved shape.

A frequency of the second light signal may be twice a frequency of the first light signal.

The device may include at least one of a semiconductor device or a display device.

According to another aspect of the disclosure, a device analysis method includes manufacturing a device, supplying a first light signal to the device at a plurality of incident angles or a plurality of azimuth angles, detecting a second light signal reflected from the device, determining whether the device is normal or defective by analyzing the second light signal, and when the device is a defective device, performing defect modeling on the defective device, wherein the performing of the defect modeling includes modeling a defect space distribution, calculating an intensity of an electric field according to a model, calculating an intensity of the second light signal based on the intensity of the electric field, and comparing the second light signal reflected from the device with the second light signal calculated by performing defect modeling.

The performing of the defect modeling may include predicting a position of a defect and a density of the defect based on a shape of the device.

The intensity of the electric field may be expressed as a function of an angle formed by an interface of the device and the electric field.

The calculating of the intensity of the electric field according to the model may be performed based on a direction of the electric field of an interface according to a position of a defect.

When the second light signal reflected from the device and the second light signal calculated by performing defect modeling are same, a defect distribution of a defect model may be selected as a defect distribution of the device.

When the second light signal reflected from the device and the second light signal calculated by performing defect modeling are different, an additional defect space distribution may be modeled.

According to another aspect of the disclosure, a device analysis apparatus includes a light source unit configured to generate and emit a first light signal, a sample unit configured to receive the first light signal and reflect the first light signal as a second light signal, a detection unit configured to detect the second light signal, and an analysis unit configured to analyze the second light signal detected by the detection unit, wherein the first light signal is configured to be incident on the sample unit at a plurality of incident angles or a plurality of azimuth angles, and the analysis unit is configured to model a defect based on a shape of a device.

At least one of relative positions of the light source unit and the sample unit or relative positions of the sample unit and the detection unit may be changed.

The sample unit may include a stage configured to support the device, and the stage may be configured to tilt, translate, and rotate.

The analysis unit may be configured to calculate a distribution of electric fields based on an intensity of the second light signal and model the defect based on the distribution of the electric fields.

The device analysis apparatus may further include a healing unit configured to heal a defective device and allow a third light signal to be incident on the defective device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating an analysis apparatus for device analysis, according to an embodiment;

FIG. 2 is a schematic diagram illustrating an analysis apparatus for device array analysis, according to an embodiment;

FIG. 3 is a flowchart of a device analysis method according to an embodiment;

FIG. 4 is a flowchart illustrating a method of performing defect modeling according to an embodiment;

FIGS. 5 and 6 are diagrams schematically illustrating a method, performed by an analysis apparatus, of inspecting a device, according to an embodiment;

FIGS. 7 and 8 are graphs showing a distribution of an electric field according to a defect model, according to an embodiment;

FIG. 9 is a cross-sectional view illustrating a shape of a device, according to an embodiment;

FIGS. 10 to 12 are graphs showing distributions of electric fields according to various defect models in a device having the shape illustrated in FIG. 9;

FIG. 13 is a graph showing a change in intensity of a non-linear (NL) signal according to an incident angle, according to an embodiment;

FIG. 14 is a graph separately showing a horizontal component and a vertical component of the NL signal of FIG. 13;

FIG. 15 is a flowchart of a device analysis method according to an embodiment;

FIG. 16 is a flowchart of a method of performing a subsequent process on a device, according to an embodiment; and

FIGS. 17 and 18 are schematic diagrams illustrating an analysis apparatus for semiconductor device analysis, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in detail with reference to the accompanying drawings. The same elements in the drawings are denoted by the same reference numerals, and redundant descriptions thereof are omitted. In the accompanying drawings, the thickness and size of each layer are exaggerated for convenience and clarity of explanation, and thus, may be slightly different from the actual shape and proportion thereof.

The singular forms as used herein are intended to include the plural forms as well unless the context clearly indicates otherwise. It will be understood that the terms “comprise,” “include,” or “have” as used herein specify the presence of the stated elements, steps, operations, and/or devices, but do not preclude the presence or addition of one or more other elements, steps, operations, and/or devices.

Although terms such as “first” or “second” are used herein to describe various areas, directions, and shapes, these areas, directions, and shapes should not be limited by these terms. These terms are only used to distinguish one area, direction, or shape from another area, direction, or shape. Accordingly, a portion referred to as a first portion in an embodiment may be referred to as a second portion in another embodiment. Embodiments described and illustrated herein also include complementary embodiments thereof. Portions that are denoted by the same reference numerals throughout the specification represent the same elements.

When an element is referred to as being provided “on” another element, it may be understood that the element is provided directly on (i.e., in direct contact with) the other component, or a third element intervenes therebetween.

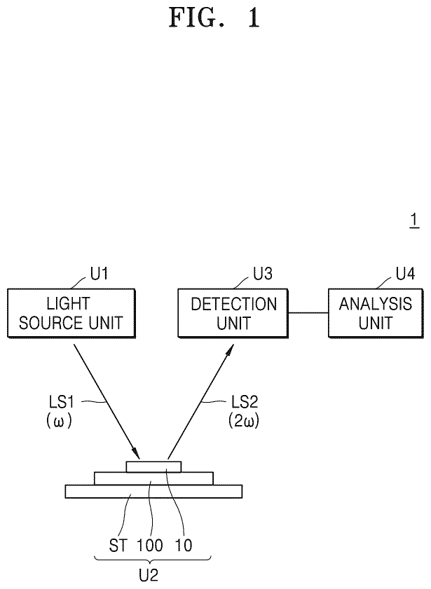

FIG. 1 is a schematic diagram illustrating an analysis apparatus 1 for device analysis, according to an embodiment.

Referring to FIG. 1, the analysis apparatus 1 may include a light source unit U1, a sample unit U2, a detection unit U3, and an analysis unit U4. The analysis apparatus 1 may analyze devices 10 based on a second harmonic generation (SHG) signal reflected from the devices 10.

The light source unit U1 may be configured to emit a first light signal LS1. The light source unit U1 may include a first laser light source unit, and the first laser light source unit may be a femtosecond (fs)-laser. In an embodiment, the light source unit U1 may be configured such that the first light signal LS1 is incident on the sample unit U2 at various angles. For example, the light source unit U1 may include a first actuator configured to move and/or rotate a first laser light source unit. The first actuator may move and/or rotate the light source unit U1 with respect to the sample unit U2. The relative positions of the light source unit U1 and the sample unit U2 may be changed by the first actuator.

The sample unit U2 may be configured to receive the first light signal LS1 and emit a second light signal LS2. A frequency 2w of the second light signal LS2 may be twice a frequency ω of the first light signal LS1. That is, the second light signal LS2 may be a SHG signal with respect to the first light signal LS1.

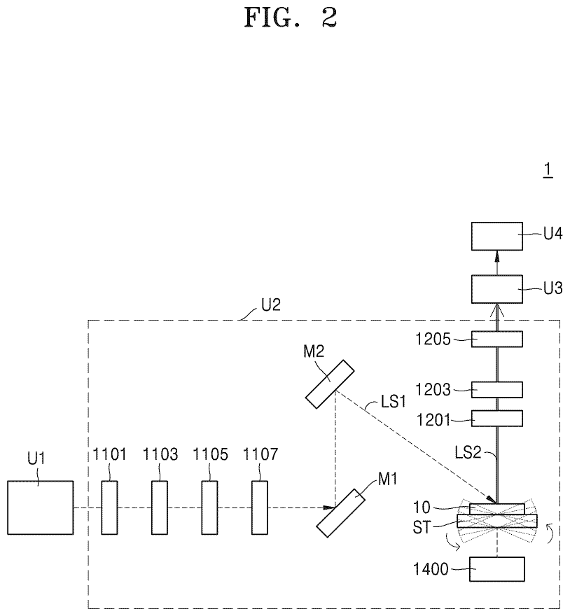

The sample unit U2 may be configured such that the devices 10 are arranged on a substrate 100. The sample unit U2 may include a stage ST configured to move the substrate 100 in a horizontal direction (an X direction and/or a Y direction) and/or a vertical direction (a Z direction). In addition, the stage ST may be configured to rotate about an axis in the vertical direction (Z direction). Also, the stage ST may be configured to be tilted. The sample unit U2 may include a second actuator configured to move and/or rotate the stage ST. By the second actuator, the relative positions of the light source unit U1 and the sample unit U2 and/or the relative positions of the sample unit U2 and the detection unit U3 may be changed. The second actuator may be referred to as a stage actuator (1400 of FIG. 2).

In the specification, a direction parallel to a main surface of the substrate 100 is defined as the horizontal direction (the X direction and/or the Y direction), and a direction perpendicular to the horizontal direction (the X direction and/or the Y direction) is defined as the vertical direction (the Z direction).

The sample unit U2 may further include a polarizer and at least one optical element disposed between the light source unit U1 and the stage ST. The optical element may be, for example, one of a bandpass filter, a long pass filter, and a dichromatic mirror. In another embodiment, the polarizer and the at least one optical element may be included in a transmitter that transmits the first light signal LS1 of the light source unit U1 to the sample unit U2.

In addition, the sample unit U2 may further include at least one optical element disposed between the stage ST and the detection unit U3. The optical element may be, for example, one of a bandpass filter, a short pass filter, a dichromatic mirror, a diffraction grating, and a spatial filter.

Each of the devices 10 to be analyzed by the analysis apparatus 1 according to the disclosure may be a transistor device including an oxide semiconductor material, a thin-film structure including an oxide semiconductor thin-film, and/or a display device, but the disclosure is not limited thereto.

The detection unit U3 may be configured to detect the second light signal LS2, and the analysis unit U4 may be configured to analyze the second light signal LS2 detected by the detection unit U3. More specifically, the analysis unit U4 may determine whether each of the devices 10 is normal or defective. Also, the analysis unit U4 may further include a control module that modifies a manufacturing process of the devices 10.

For example, the detection unit U3 may include a third actuator that moves and/or rotates a detection unit that detects the second light signal LS2. The third actuator may move and/or rotate the detection unit U3 with respect to the sample unit U2. The relative positions of the detection unit U3 and the sample unit U2 may be changed by the third actuator.

In an embodiment, the analysis unit U4 may perform defect modeling for predicting a distribution of defects in the devices 10. The distribution of defects may include positions of defects and densities of defects. The analysis unit U4 may perform defect modeling based on the intensity of the second light signal LS2 detected by the detection unit U3. The analysis unit U4 may perform defect modeling based on the intensity of the second light signal LS2 detected by the detection unit U3 according to a plurality of incident angles and/or a plurality of azimuth angles.

In another embodiment, the detection unit U3 may be configured to obtain an image based on the detected second light signal LS2. For example, the detection unit U3 may include a complementary metal oxide semiconductor (CMOS) image sensor. For example, the detection unit U3 may include a charge-coupled device (CCD) image sensor.

In an embodiment, the detection unit U3 may obtain an image of each of the devices 10. In another embodiment, the detection unit U3 may obtain an image of each of a plurality of unit devices in a device array including the plurality of devices 10. In addition, the detection unit U3 may obtain an image of a unit device located at a specific position in the device array.

In an embodiment, the detection unit U3 may obtain an image by using an algorithm of combining spot spectra. In another embodiment, the detection unit U3 may directly obtain an image.

The analysis unit U4 may be configured to analyze the image obtained by the detection unit U3. The analysis unit U4 may calculate a threshold voltage of each of the plurality of devices 10 and/or a defect density of each of the plurality of devices 10, based on the image obtained by the detection unit U3. In an embodiment, the analysis unit U4 may calculate the threshold voltage of each of the plurality of devices 10 and/or the defect density of each of the plurality of devices 10, based on the intensity of the second light signal LS2.

In addition, when calculating the threshold voltage of each of the plurality of devices 10 and/or the defect density of each of the plurality of devices 10, based on the intensity of the second light signal LS2, the analysis unit U4 may correct and analyze the image based on distribution information of the first light signal LS1 previously stored in a database.

FIG. 2 is a schematic diagram illustrating the analysis apparatus 1 for device array analysis, according to an embodiment. The following description is given with reference to FIG. 1.

Referring to FIG. 2, the analysis apparatus 1 may include the light source unit U1, the sample unit U2, the detection unit U3, and the analysis unit U4. The sample unit U2 may be provided between the light source unit U1 and the detection unit U3. The sample unit U2 may include a first bandpass filter 1101, a polarizer 1103, a beam shaper 1105, and a first beam expander 1107, which are located on a path that connects the light source unit U1 to the stage ST.

The first light signal LS1 that is generated and emitted from the light source unit U1 may pass through the first bandpass filter 1101, the polarizer 1103, the beam shaper 1105, and the first beam expander 1107 and may travel toward the detection unit U3. The first light signal LS1 may be incident on the devices 10 to generate an SHG signal.

The first bandpass filter 1101 may block light with another frequency such that only light with a specific frequency is selectively incident on the devices 10. In an embodiment, at least one optical device, such as a long pass filter or a dichromatic mirror, may be provided instead of the first bandpass filter 1101. The polarizer 1103 may circularly polarize and/or linearly polarize the first light signal LS1. The polarization of the polarizer 1103 may be determined based on a process of measuring the devices 10 and/or states of the devices 10.

The beam shaper 1105 may shape the first light signal LS1. In an embodiment, the beam shaper 1105 may shape the first light signal LS1 having a Gaussian peak shape to have a constant intensity according to space. The beam shaper 1105 may shape the first light signal LS1, such that a deviation in the intensity of the first light signal LS1 incident on each of the devices 10 may be reduced when the first light signal LS1 is simultaneously incident on the plurality of devices 10. For example, the beam shaper 1105 may include a micro lens array and/or a diffractive optical element.

In addition, the first beam expander 1107 may adjust a diameter of the first light signal LS1. For example, the first beam expander 1107 may reduce and/or expand the diameter of the first light signal LS1. The first light signal LS1 that has passed through the beam shaper 1105 and the first beam expander 1107 may be incident on the devices 10.

The sample unit U2 may further include a plurality of mirrors located on a path that connects the light source unit U1 to the stage ST. For example, the sample unit U2 may include a first mirror M1 and a second mirror M2. The first mirror M1 and the second mirror M2 may adjust an incident angle of the first light signal LS1 incident on the devices 10. In addition, the first mirror M1 and the second mirror M2 may be configured to maintain a pulse width of the first light signal LS1. For example, the first mirror M1 and the second mirror M2 may each include an ultrafast mirror.

In addition, the sample unit U2 may include a second bandpass filter 1201 and a lens 1203, which are located on a path that connects the detection unit U3 to the stage ST.

The second bandpass filter 1201 may block light with another frequency such that only light with a specific frequency is selectively incident on the detection unit U3. In an embodiment, an optical device, such as a short pass filter, a dichromatic mirror, and a diffraction grating, may be provided instead of the second bandpass filter 1201.

In an embodiment, the second bandpass filter 1201 may be configured such that the second light signal LS2 having twice the frequency of the first light signal LS1 is incident on the detection unit U3. That is, the second light signal LS2 may be an SHG light with respect to the first light signal LS1. The lens 1203 may be configured to change the magnification and/or resolution of a specific region of the substrate 100.

In addition, the sample unit U2 may be located on a path that connects the detection unit U3 to the stage ST and may further include optical elements configured to remove interference between different second light signals LS2 generated by the plurality of devices 10. For example, the optical element may include a polarizer, a diffraction grating, a spatial filter, and/or a signal processor. The signal processor may be configured to distinguish between interfered light and non-interfered light. The optical element may be referred to as an interference remover 1205.

In addition, the sample unit U2 may further include a stage actuator 1400 to move, rotate, and/or tilt the stage ST. The stage actuator 1400 may operate such that the incident angle and/or azimuth angle of the first light signal LS1 incident on the sample unit U2 may be changed.

In FIGS. 1 and 2, the sample unit U2 has been described as including the first bandpass filter 1101, the polarizer 1103, the beam shaper 1105, the first beam expander 1107, the first mirror M1, the second mirror M2, the second bandpass filter 1201, the lens 1203, the interference remover 1205, and the actuator 1400, but this is a formal distinction for convenience of explanation, and at least one of the first bandpass filter 1101, the polarizer 1103, the beam shaper 1105, the first beam expander 1107, the second bandpass filter 1201, the lens 1203, the interference remover 1205, and the actuator 1400 may be included in the light source unit U1, the detection unit U3, and/or the analysis unit U4.

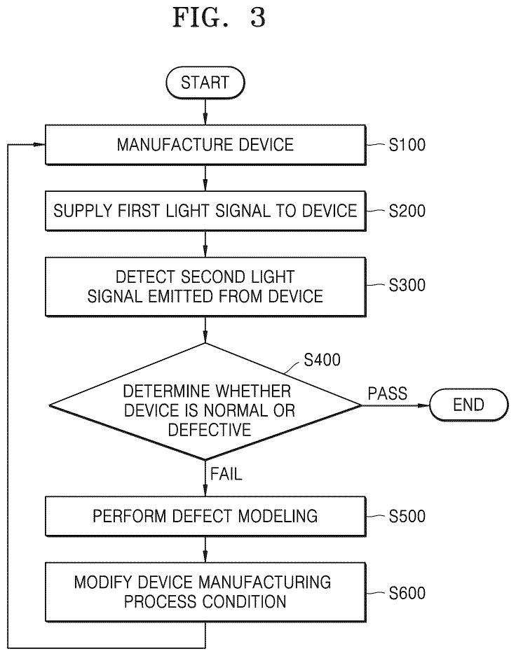

FIG. 3 is a flowchart of a device analysis method according to an embodiment.

Referring to FIG. 3, the device analysis method of the disclosure may include operation S100 of manufacturing a device, operation S200 of supplying a first light signal to the device, operation S300 of detecting a second light signal emitted from the device, and operation S400 of determining whether the device is normal or defective by analyzing the detected second light signal. When the device is a normal device (pass), the process may proceed to an end operation, and when the device is a defective device (fail), the process may proceed to operation S500. In an embodiment, operation S400 of determining whether the device is normal or defective may determine whether the device 10 is normal or defective based on the intensity of the second light signal LS2. For example, when the intensity of the second light signal LS2 is within a reference value, the device 10 may be determined as the normal device, and when the intensity of the second light signal LS2 is outside the reference value, the device 10 may be determined as the defective device.

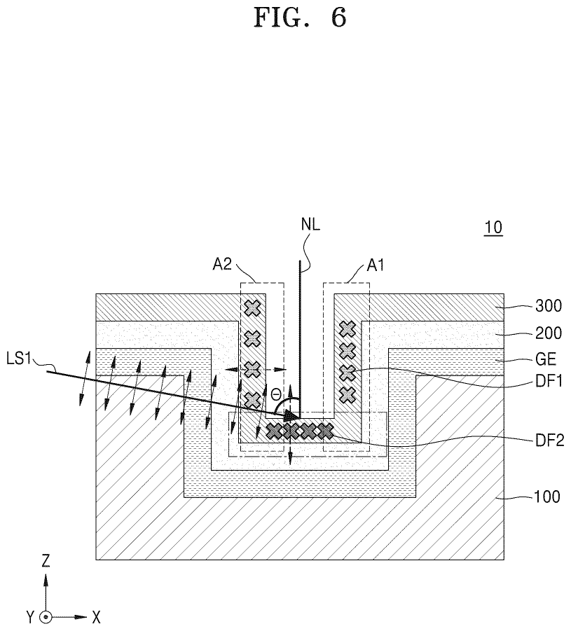

In an embodiment, operation S200 of supplying the first light signal to the device may include supplying the first light signal LS1 to the device 10 at one or more incident angles and/or one or more azimuth angles. The incident angle may be an angle between the first light signal LS1 and a line (a normal line, NL of FIG. 6) perpendicular to a surface of the device. For example, the incident angle may be an angle between the first light signal LS1 and a line extending in the vertical direction (Z direction). The azimuth angle may be an angle between a reference axis (e.g., an X axis or a Y axis) and a line extending from the origin to a target point on a horizontal plane.

In another embodiment, operation S200 of supplying the first light signal to the device may include a step of supplying the first light signal LS1 having one or more polarization components to the device.

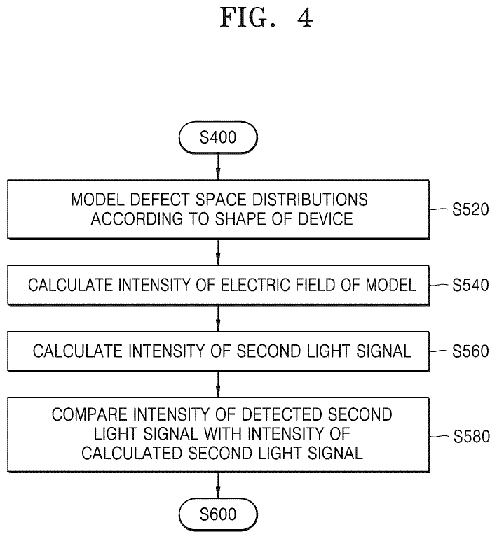

The device analysis method of the disclosure may further include operation S500 of performing defect modeling on the defective device when the device to be inspected is the defective device. Operation S500 of performing defect modeling may include a step of calculating a distribution of defects of the device 10 based on the intensity of an electric field signal according to the incident angle and/or azimuth angle of the first light signal LS1. Operation S500 of performing defect modeling will be described in more detail with reference to FIGS. 4 to 8.

FIG. 4 is a flowchart illustrating a method of performing defect modeling according to an embodiment.

Referring to FIG. 4, various defect space distributions according to the shape of the device 10 may be modeled (S520). For example, when the device 10 includes a bottom portion extending in the horizontal direction (X and/or Y direction) and a side surface portion extending in the vertical direction (Z direction), defects may be present only on the bottom portion, only on the side surface portion, or both the bottom portion and the side surface portions.

Thereafter, the intensity of an electric field according to a model may be calculated (S540). In an embodiment, the intensity of the electric field according to an angle between an interface and the electric field may be calculated. In an embodiment, the defect present on the bottom portion may cause an electric field generated at the interface to vibrate in the vertical direction (Z direction), and the defect present on the side portion may cause an electric field generated at the interface to vibrate in the horizontal direction (X direction and/or Y direction). An electric field component generated by the first light signal LS1 forming a resonance with the electric field generated at the interface may not be offset. Here, the electric field generated by the first light signal LS1 may be referred to as a first electric field, and the electric field generated at the interface may be referred to as a second electric field.

Thereafter, the intensity of a second light signal LS2 (second harmonic signal) may be calculated based on the intensity of the electric field (S560). The second light signal LS2 may be calculated based on Equation 1 below.

$$I ( θ ) ∝ {\int }_{0}^{90} {E}^{2} ( ϕ ) sin \vert θ - ϕ \vert d ϕ \qquad [ Equation 1 ]$$

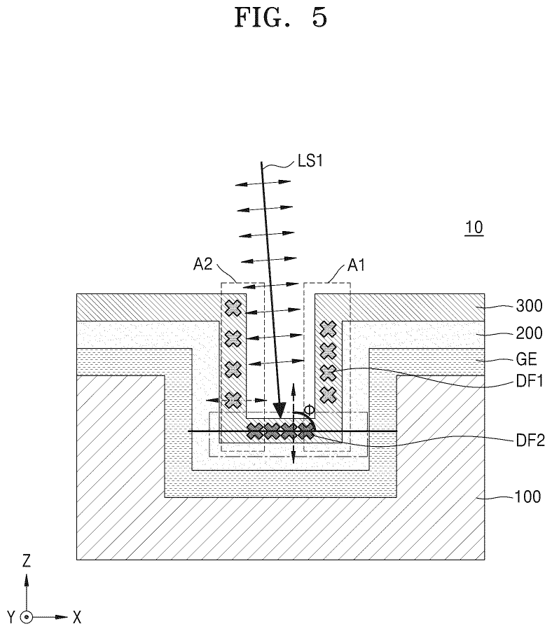

Here, I (θ) denotes the intensity of the second light signal LS2 according to the incident angle, θ denotes an incident angle of the first light signal LS1, E(ϕ) denotes the intensity of the electric field according to the angle, and ϕ denotes the angle of the electric field with respect to the interface. <<mth4>> is shown in FIGS. 5, and θ is shown in FIG. 6.

Therefore, the distribution of the electric field may be inversely calculated based on the second light signal LS2 detected by the detection unit U3. That is, defects of the device 10 may be modeled based on the distribution of the electric field.

Thereafter, the second light signal LS2 detected in operation S300 may be compared with the second light signal LS2 calculated in operation S560 (S580). The second light signal LS2 detected in operation S300 may be a detected second light signal, and the second light signal LS2 calculated in operation S560 may be a calculated second light signal.

When a graph of the second light signal LS2 obtained in operation S300 and a graph of the second light signal LS2 obtained in operation S560 are different from each other, the process proceeds to operation S520, additional defect space distribution may be modeled, and operations S540 and S560 may be repeatedly performed. When the graph of the second light signal LS2 obtained in operation S300 and the graph of the second light signal LS2 obtained in operation S560 are the same, the process may proceed to operation S600.

Returning to FIG. 3 again, after operation S500 of performing defect modeling, the device analysis method of the disclosure may further include operation S600 of modifying a device manufacturing process condition. Operation S600 of modifying the device manufacturing process condition may include modifying at least one of a material composition, oxygen partial pressure, plasma power, pressure, a heat treatment atmosphere, and a heat treatment temperature during the manufacturing process of the device 10.

After operation S600 of modifying the device manufacturing process condition is performed, the process including operation S100 of manufacturing the device, operation S200 of supplying the first light signal to the device, operation S300 of detecting the second light signal emitted from the device, and operation S400 of determining whether the device is normal or defective by analyzing the detected second light signal may be repeatedly performed. The process may be performed until the device 10 includes a normal device.

In another embodiment, a device array including the plurality of devices 10 instead of the single device 10 may be analyzed.

In another embodiment, operation S300 of detecting the second light signal emitted from the device may include an operation of obtaining an image of the second light signal LS2 emitted from the device 10. In addition, operation S400 may include determining whether the device 10 is normal or defective by analyzing the image.

An operation of obtaining the image by detecting the second light signal LS2 generated by the device 10 may include an operation of detecting the second light signal LS2 generated by the device 10 and an operation of removing interference of the second light signal LS2 emitted from the device 10. For example, the operation of obtaining the image by detecting the second light signal LS2 may include detecting a second light signal spectrum.

In an embodiment, the device analysis method of the disclosure may further include an operation of storing the image and/or information about the image in a database after the operation of obtaining the image by detecting the second light signal LS2. In an embodiment, the operation of analyzing the image may include analyzing the image based on information previously stored in the database.

In an embodiment, the device analysis method of the disclosure may include analyzing the image by correcting a difference according to a position of the first light signal LS1 of the image obtained based on distribution information of the first light signal LS1 previously stored in the database after the operation of obtaining the image by detecting the second light signal LS2.

FIGS. 5 and 6 are diagrams schematically illustrating a method, performed by an analysis apparatus, of inspecting the device 10, according to an embodiment. In FIGS. 5 and 6, an arrow including a two-point chain line indicates a direction of an electric field generated at an interface by a first defect DF1, and an arrow including a dotted line indicates a direction of an electric field generated at an interface by a second defect DF2.

Referring to FIGS. 5 and 6, the device 10 may include a gate electrode GE, a gate insulating layer 200, and a semiconductor layer 300 sequentially formed on the substrate 100. In FIGS. 5 and 6, a cross section of the device 10 includes a first area A1 extending in the horizontal direction (X direction and/or Y direction) and a second area A2 extending in the vertical direction (Z direction). For example, the first area A1 may be referred to as a bottom portion, and the second area A2 may be referred to as a side surface portion.

The substrate 100 on which the devices 10 are arranged may be a semiconductor substrate including at least one of silicon, germanium, or silicon-germanium, a compound semiconductor substrate, a glass substrate, or a plastic substrate. For example, the substrate 100 may be a silicon wafer. According to some embodiments, the device 10 may be formed in a front-end-of-line (FEOL) layer or a back-end-of-line (BEOL) layer on the substrate 100, or a peripheral circuit structure.

For example, the gate electrode GE may include at least one of a doped semiconductor material (doped silicon, doped germanium, etc.), conductive metal nitride (titanium nitride, tantalum nitride, tungsten nitride, etc.), or a metal material (titanium, tantalum, tungsten, copper, aluminum, ruthenium, molybdenum, etc.).

For example, the gate insulating layer 200 may include at least one of silicon oxide, silicon nitride, silicon oxynitride, or a high-k material. The high-k material may be a material having a dielectric constant greater than that of silicon oxide and silicon nitride, such as hafnium oxide, aluminum oxide, or tantalum oxide.

For example, the semiconductor layer 300 may include an oxide semiconductor layer, a semiconductor material including silicon, and/or a two-dimensional (2D) material. For example, the semiconductor layer 300 may include a compound of oxygen (O) and at least two elements selected from the group consisting of hydrogen (H), zinc (Zn), indium (In), gallium (Ga), tin (Sn), tantalum (Ta), strontium (Sr), titanium (Ti), copper (Cu), rhodium (Rh), and aluminum (Al).

When the first light signal LS1 is supplied to the device 10, the second light signal LS2 may be generated by an electric field at an interface between the gate insulating layer 200 and the semiconductor layer 300. At this time, the second light signal LS2 may be a non-linear (NL) signal having an energy that is integer multiple of the initial photon generated by the electric field at the interface between the gate insulating layer 200 and the semiconductor layer 300.

FIGS. 5 and 6 illustrates a method of analyzing the semiconductor layer 300. When a defect is present inside the semiconductor layer 300, a direction of the electric field generated at the interface between the gate insulating layer 200 and the semiconductor layer 300 may vary depending on a position of the defect.

For convenience of description, the semiconductor layer 300 extending in the horizontal direction (X direction and/or Y direction) may be referred to as the first area A1, and the semiconductor layer 300 extending in the vertical direction (Z direction) may be referred to as the second area A2. In addition, a defect disposed in the first area A1 may be referred to as the first defect DF1, and a defect disposed in the second area A2 may be referred to as the second defect DF2.

In an embodiment, an electric field (second electric field) generated at the interface due to the first defect DF1 may vibrate in the horizontal direction (X direction and/or Y direction), and the electric field (second electric field) generated at the interface due to the second defect DF2 may vibrate in the vertical direction (Z direction).

Therefore, when a direction of the electric field (second electric field) generated at the interface is the same as a direction of an electric field (first electric field) generated by the first light signal L1, the first electric field and the second electric field may be reinforced to increase the intensity of the electric field. On the contrary, when the direction of the electric field (second electric field) generated at the interface is different from the direction of the electric field (first electric field) generated by the first light signal L1, the first and second electric fields may be offset to reduce the intensity of the electric field.

In FIG. 5, the first electric field may be incident in a direction close to the horizontal direction (X direction and/or Y direction), and in FIG. 6, the first electric field may be incident in a direction close to the vertical direction (Z direction). This may be achieved by changing an incident angle of the first light signal LS1. As described above, the incident angle may be an angle formed by the first light signal LS1 and the normal line NL.

When the first electric field has the direction close to the horizontal direction (X direction and/or Y direction), the first electric field may be reinforced with the second electric field vibrating in the horizontal direction (X direction and/or Y direction). On the contrary, when the first electric field has the direction close to the vertical direction (Z direction), the first electric field may be reinforced with the second electric field vibrating in the vertical direction (Z direction). That is, in FIG. 5, the second electric field generated by the first defect DF1 may be reinforced with the first electric field, and in FIG. 6, the second electric field generated by the second defect DF2 may be reinforced with the first electric field.

Therefore, when the intensity of the electric field is measured while changing the incident angle of the first light signal LS1, defect modeling of the device 10 may be performed. From a similar point of view, when the intensity of the electric field is measured while changing an azimuth angle of the first light signal LS1, defect modeling of the device 10 may be performed.

Also, the intensity of the second light signal LS2 may be calculated based on the intensity of the electric field. That is, defect modeling of the device 10 may be performed based on the intensity of the second light signal LS2.

However, the configuration of the device 10 shown in FIGS. 5 and 6 is an example, and may be variously modified. In addition, an arrangement of components of the device 10 may also be variously modified.

In an embodiment, the device 10 may include a 2D device and/or a three-dimensional (3D) device. The 2D device may be a device in which components of the device are arranged in a 2D structure. The 3D device may be a device in which components of the device are arranged in a 3D structure. For example, the 2D device may be a device in which a source, a drain, and a channel have a 2D structure. The 3D device may be a device in which a source, a drain, and a channel have a 3D structure.

For example, a 2D device may include a planar field effect transistor (FET). For example, the 3D device may include fin FET (FINFET) and gate-all-around FET (GAAFET).

The analysis apparatus of the disclosure may analyze devices of various dimensions with high reliability. In more detail, the analysis apparatus of the disclosure may analyze the device 10 based on the shape of the device 10 and analyze not only the 2D device but also the 3D device with high reliability.

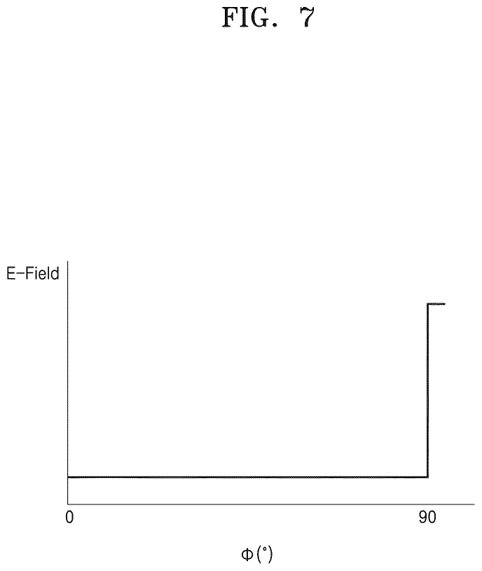

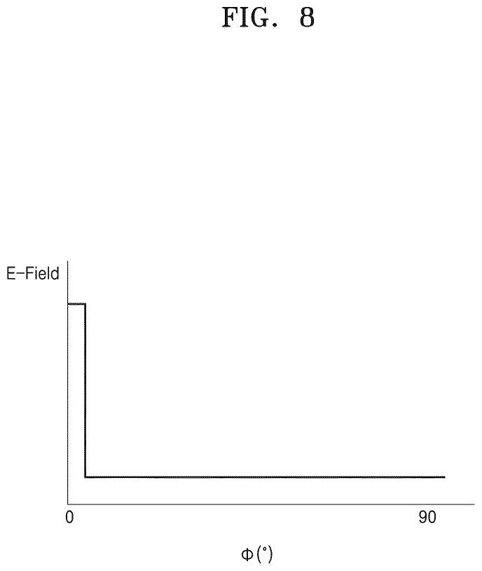

FIGS. 7 and 8 are graphs showing a distribution of an electric field according to a defect model, according to an embodiment. The following descriptions are given with reference to FIGS. 1, 5 and 6.

Referring to FIGS. 7 and 8, the distribution of the electric field in the device 10 having the shape of FIGS. 5 and 6 is illustrated. As described above, in FIGS. 5 and 6, an interface of a cross section of the device 10 includes the first area A1 extending in the horizontal direction (X direction and/or Y direction) and the second area A2 extending in the vertical direction (Z direction). As can be seen in FIGS. 7 and 8, even when the shape of the device (10) is the same, the distribution of electric fields may be different depending on the distribution of defects.

In an embodiment, the distribution of the electric field may be inversely calculated based on the second light signal LS2 detected by the detection unit U3. Therefore, a defect of the device 10 may be modeled based on the intensity of the second light signal LS2.

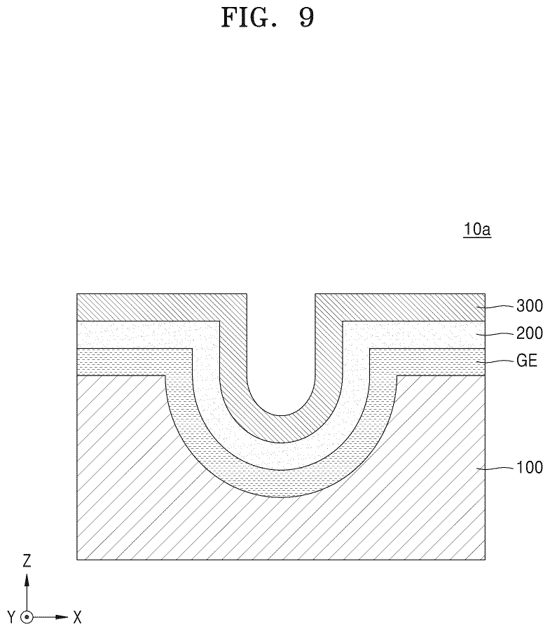

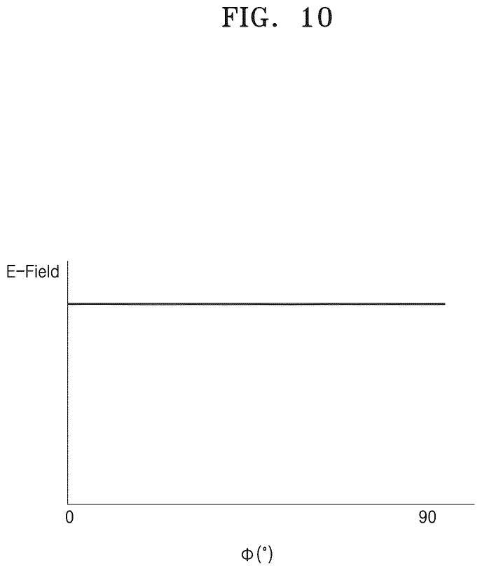

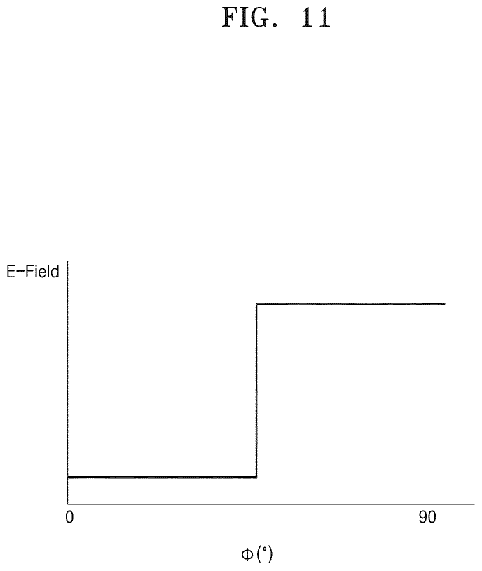

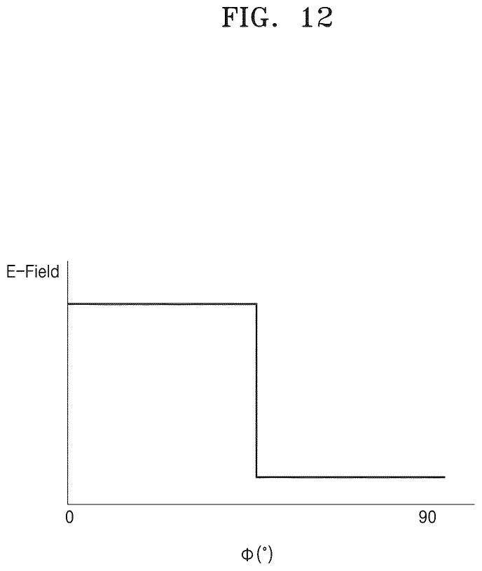

FIG. 9 is a cross-sectional view illustrating a shape of a device 10a, according to an embodiment. FIGS. 10 to 12 are graphs showing distributions of electric fields according to various defect models in the device 10a having the shape illustrated in FIG. 9.

Referring to FIGS. 9 to 12, an interface of a cross section of the device 10a is curved in FIG. 9. As may be confirmed in FIGS. 10 to 12, even when the device 10a has the same shape, distributions of electric fields may vary depending on distributions of defects. Therefore, the distributions of electric fields may be inversely calculated based on the second light signal LS2 detected by the detection unit U3. Defects of the device 10a may be modeled based on the distributions of the electric fields.

In FIGS. 5 and 6, the interface of the cross section of the device 10 includes the first area A1 extending in the horizontal direction (X direction and/or Y direction) and the second area A2 extending in the vertical direction (Z direction), and in FIG. 9, the interface of the cross section of the device 10a is curved. However, the shapes of the devices 10 and 10a are not limited thereto, and may be variously modified.

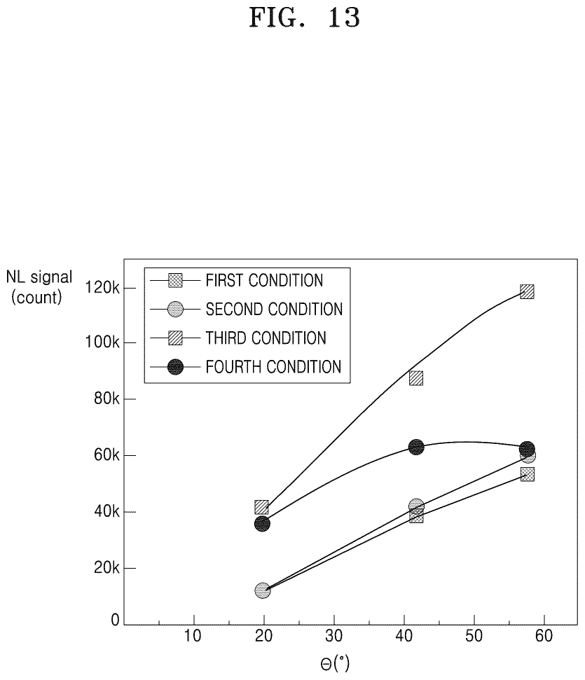

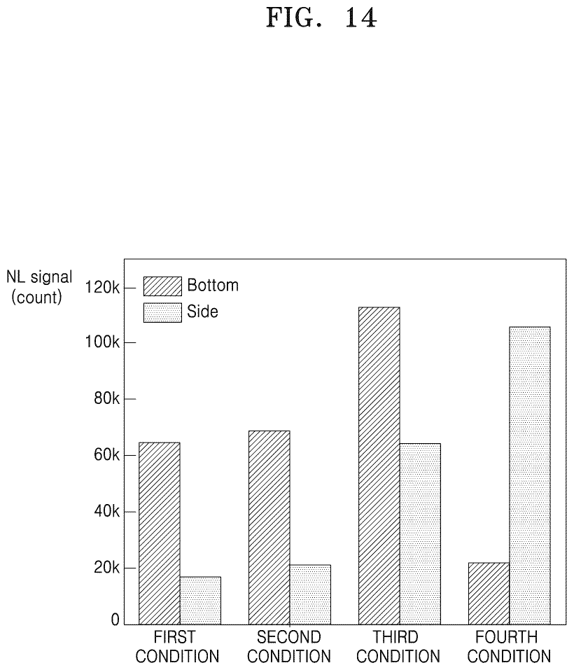

FIG. 13 is a graph showing a change in intensity of an NL signal according to an incident angle, according to an embodiment. FIG. 14 is a graph separately showing a horizontal component and a vertical component of the NL signal of FIG. 13. In FIG. 13, the horizontal axis represents the incident angle θ of the first light signal LS1 and the vertical axis represents the intensity of the NL signal. In FIG. 14, the vertical axis represents the intensity of the NL signal. In FIG. 13, a unit of the horizontal axis is ° (degrees) in the unit of the incident angle θ, and a unit of the vertical axis is count. In FIG. 14, a unit of the vertical axis is count.

In FIG. 13, trends of the intensity of the NL signal according to an incident angle in first to fourth conditions are illustrated. For example, the first condition represents the intensity of the NL signal in a normal device, and the second to fourth conditions represent the intensities of the NL signal in a defective device. The second condition indicates that a defect is disposed in a portion (side surface portion) extending in the vertical direction (Z direction), the third condition indicates that a defect is disposed in a portion (bottom portion) extending in the horizontal direction (X direction and/or Y direction) and the portion (side surface portion) extending in the vertical direction (Z direction), and the fourth condition indicates that a plurality of defects are disposed.

In FIG. 13, an area in which the incident angle θ is relatively close to 0° may be an area related to the defect disposed in the portion (bottom portion) extending in the horizontal direction (X and/or Y direction), and an area in which the incident angle θ is relatively close to 90° may be an area related to the defect disposed in the portion (side surface portion) extending in the vertical direction (Z direction).

The intensity of the NL signal according to the incident angle θ obtained in FIG. 13 may be expressed by Equation 2 below.

I(θ)∝Asin θ+Bcosθ [Equation 2]

Here, I(θ) indicates the intensity of the NL signal according to the incident angle, θ indicates the incident angle of the first light signal LS1, A indicates a coefficient of the bottom portion, and B indicates a coefficient of the side surface portion.

FIG. shows the graph showing the graph obtained in FIG. 13 which is divided by the coefficient of the bottom portion and the coefficient of the side surface portion through Equation 2 above.

By comparing the coefficient of the bottom portion with the coefficient of the side surface portion under each condition, a position of a defect, a defect density, and whether it is normal/defective may be calculated. For example, because the coefficient of the bottom portion of the second condition is higher than the coefficient of the bottom portion of the first condition, it may be confirmed that the defect is present on the bottom portion in the second condition. In addition, because the coefficient of the bottom portion and the coefficient of the side surface portion of the third condition are higher than the coefficient of the bottom portion and the coefficient of the side surface portion of the first condition, it may be confirmed that the defect is present on the bottom portion and the side surface portion in the third condition. In addition, because the coefficient of the side surface portion of the fourth condition is significantly higher than the coefficient of the side surface portion of the first condition, it may be confirmed that many defects are present on the side surface portion in the fourth condition. In addition, the density of defect may be calculated by comparing the coefficient of the bottom portion and the coefficient of the side surface portion of the first condition with the coefficient of the bottom portion and the coefficient of the side surface portion in each condition. That is, the defect density of the second condition may be lower than the defect density of each of the third condition and the fourth condition.

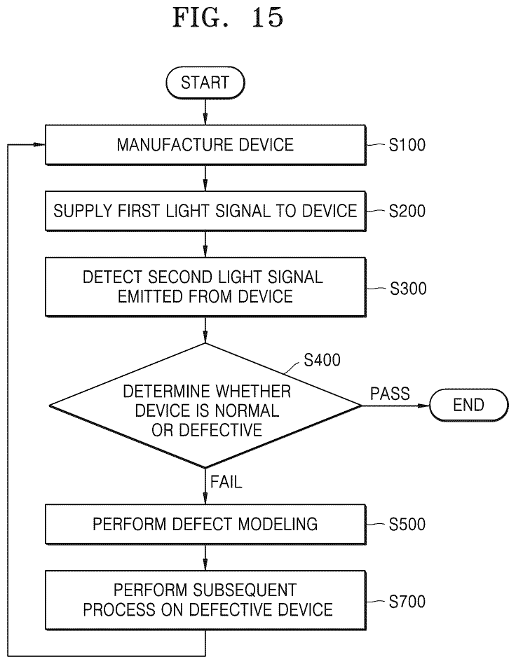

FIG. 15 is a flowchart of a device analysis method according to an embodiment. The following description is given with reference to FIGS. 1 to 3 together.

Referring to FIG. 15, the device analysis method of the disclosure may include operation S100 of manufacturing a device, operation S200 of supplying a first light signal to the device, operation S300 of detecting a second light signal emitted from the device, operation S400 of determining whether the device is normal or defective by analyzing the detected second light signal, and operation S500 of performing defect modeling. Operations S100 to S500 of FIG. 15 may be substantially the same as operations S100 to S500 of FIG. 3, respectively.

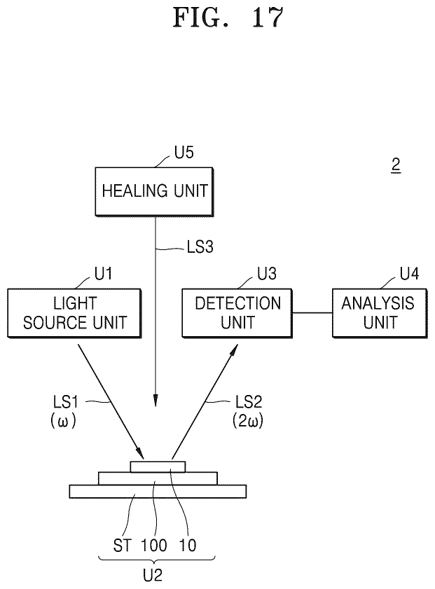

When the device includes a defective device, the device analysis method of the disclosure may include operation S700 of performing a subsequent process on the defective device. Operation S700 of performing the subsequent process on the defective device may include an operation of finding the defective device that requires the subsequent process by moving the stage ST where the device is provided and an operation of supplying the third light signal (LS3 of FIG. 17) to the defective device. In an embodiment, the third light signal (LS3 of FIG. 17) may have a different path or source from the first light signal LS1. In another embodiment, the third light signal (LS3 of FIG. 17) may have the same path and source as the first light signal LS1. In this case, the intensity and/or energy of the third light signal (LS3 of FIG. 17) may be different from the intensity and/or energy of the first light signal LS1.

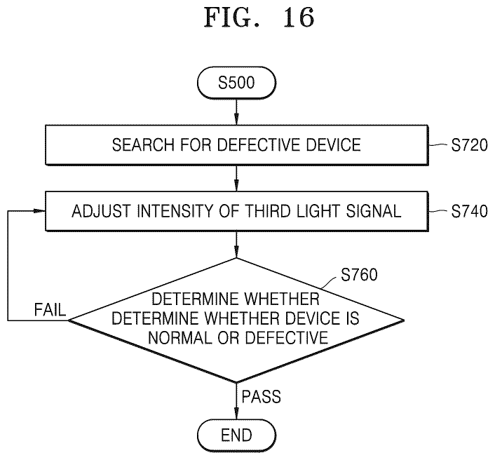

Electrical characteristics of the defective device may be changed (i.e., improved) by the subsequent process. According to the device analysis method described with reference to FIG. 3, the electrical characteristics of the specific device 10 in the substrate 100 on which the devices 10 are arranged may be changed (i.e., improved). Operation S700 of performing the subsequent process on the defective device will be described in detail with reference to FIG. 16.

After operation S700 of performing the subsequent process on the defective device is performed, the process including operation S100 of manufacturing the device, operation S200 of supplying the first light signal to the device, operation S300 of detecting the second light signal emitted from the device, operation S400 of determining whether the device is normal or defective by analyzing the detected second light signal, and operation S500 of performing defect modeling may be repeatedly performed. The process may be performed until the device 10 includes only a normal device.

FIG. 16 is a flowchart of a method of performing a subsequent process on a device, according to an embodiment. The following description is given with reference to FIG. 15.

Referring to FIG. 16, the method of performing the subsequent process on a defective device of the disclosure may include operation S720 of searching for the defective device by moving the stage ST, operation S740 of adjusting the intensity of the third light signal (LS3 of FIG. 17), and operation S760 of determining whether the device is normal or defective.

As described above, to perform the subsequent process on the defective device, the third light signal (LS3 of FIG. 17) may be controlled to be incident on the defective device by moving the stage ST. For example, the stage ST may be moved in the horizontal direction (X and/or Y direction) and/or the vertical direction (Z direction) to control the third light signal (LS3 of FIG. 17) to be incident on the defective device.

Thereafter, the intensity of the third light signal (LS3 of FIG. 17) may be adjusted based on a degree of defect of the defective device and/or a defect density of the defective device (S740). For example, as the degree of defect of the defective device increases and/or the defect density of the defective device increases, the intensity of the third light signal (LS3 of FIG. 17) may increase. On the contrary, as the degree of defect of the defective device decreases and/or the defect density of the defective device decreases, the intensity of the third light signal (LS3 of FIG. 17) may decrease. Here, the degree of defect of the defective device may be proportional to a difference between a design threshold voltage value and a measured threshold voltage value of the defective device. That is, the intensity of the third light signal LS3 of FIG. 17 may be adjusted based on a threshold voltage of the defective device.

Thereafter, it may be determined whether the device is normal or defective (S760). Operation S760 may be substantially the same as operation S200 of supplying the first light signal to the device, operation S300 of detecting the second light signal emitted from the device, and operation S400 of determining whether the device is normal or defective by analyzing the detected second light signal. When the device is a normal device, the process may proceed to an end operation (pass), and when the device is the defective device (fail), the process may proceed to operation S740.

In another embodiment, operation S700 may be performed on a device array including one or more devices. A method of performing the subsequent process on the device array may include operation of searching for a defective device array by moving the stage ST, operation of adjusting the intensity of the third light signal (LS3 of FIG. 17), and operation of determining whether the device array is normal or defective.

As described above, the device array including the defective device may be classified as a defective device array. To the contrary, a device array including only a normal device may be classified as a normal device array. To perform the subsequent process on the defective device array, the third light signal (LS3 of FIG. 17) may be controlled to be incident on the defective device array by moving the stage ST. For example, the third light signal (LS3 of FIG. 17) may be controlled to be incident on the defective device array by moving the stage ST in the horizontal direction (X and/or Y direction) and/or the vertical direction (Z direction).

Thereafter, the intensity of the third light signal (LS3 in FIG. 17) may be adjusted based on the number of defective devices included in the defective device array, a degree of defect of the defective device, and/or a defect density of the defective device array. For example, the intensity of the third light signal (LS3 in FIG. 17) may increase as the number of defective devices included in the defective device array increases, the degree of defect of the defective device increases, and/or the defect density of the defective device array increases. On the contrary, the intensity of the third light signal (LS3 in FIG. 17) may decrease as the number of defective devices included in the defective device array decreases, the degree of defect of the defective device decreases, and/or the defect density of the defective device array decreases. Here, the degree of defect of the defective device may be proportional to a difference between a design threshold voltage value and a measured threshold voltage value of the defective device. That is, the intensity of the third light signal (LS3 of FIG. 17) may be adjusted based on a threshold voltage of the defective device.

Thereafter, it may be determined whether the device array is normal or defective. An operation of determining whether the device array is normal or defective may be substantially the same as an operation of supplying the first light signal LS1 to the device array, an operation of obtaining an image by detecting the second light signal LS2 emitted from the device array, and an operation of determining whether each of the plurality of devices included in the device array is normal or defective by analyzing the image. When the device array includes only the normal device (pass), the process may proceed to an end operation, and when the device array includes the defective device (fail), the process may proceed to an operation of determining whether the device array is normal or defective.

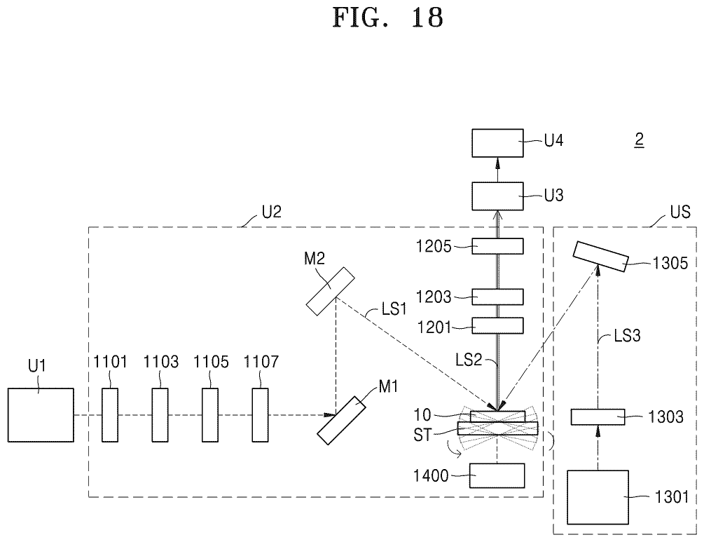

FIGS. 17 and 18 are schematic diagrams illustrating an analysis apparatus 2 for semiconductor device analysis, according to an embodiment. The following description is given with reference to FIGS. 15 and 16 together.

Referring to FIGS. 17 and 18, the analysis apparatus 2 may include the light source unit U1, the sample unit U2, the detection unit U3, the analysis unit U4, and the healing unit U5. The light source unit U1, the sample unit U2, the detection unit U3, and the analysis unit U4 of the analysis apparatus 2 in FIG. 17 are substantially the same as the light source unit U1, the sample unit U2, the detection unit U3, and the analysis unit U4 of the analysis apparatus 1 in FIG. 3, and thus, the healing unit U5 is mainly described.

The healing unit U5 may be configured to heal a defective device and/or a defective device array. The healing unit U5 may change electrical characteristics of the defective device by irradiating the third light signal LS3 onto the defective device. In an embodiment, the healing unit U5 may be configured to irradiate the third light signal LS3 onto the device array including defective devices. In addition, the intensity of the third light signal LS3 may be controlled according to the number and/or degree of defective devices included in the device array.

The healing unit U5 may include a healing light source unit 1301 and a second beam expander 1303. The healing light source unit 1301 may generate and emit light that is different from light generated and emitted by the light source unit U1. For example, the healing light source unit 1301 may generate and emit the third light signal LS3 that has ultraviolet and/or visible light wavelengths. However, the disclosure is not limited thereto, and any light may be used as long as the light heals the device 10. In addition, the second beam expander 1303 may adjust a diameter of the third light signal LS3. For example, the second beam expander 1303 may reduce and/or expand the diameter of the third light signal LS3.

In an embodiment, the healing unit U5 may be configured to make the third light signal LS3 be incident on the defective device and/or the device array including the defective device. That is, the healing unit U5 may be configured to make the third light signal LS3 be incident on both the defective device and a normal device. In this case, a process of precisely aligning a path of the third light signal LS3 with the defective device 10 is omitted, and the defective device may be healed quickly and easily. In another embodiment, the healing unit U5 may be configured to make the third light signal LS3 be incident on the defective device.

The analysis apparatus 2 according to the disclosure may further include one or more mirrors 1305 and/or one or more lenses between the second beam expander 1303 and the stage ST. The one or more mirrors 1305 and/or the one or more lenses may adjust an incident angle at which the third light signal LS3 is incident on the sample unit U2.

The healing unit U5 having a different configuration from that of the light source unit U1 is illustrated in FIGS. 17 and 18, but the disclosure is not limited thereto. For example, the healing unit U5 may be integrally formed with the light source unit U1.

According to the disclosure, a device may be analyzed by using an NL light generated from light incident at various incident angles and/or various azimuth angles. Accordingly, a quick and accurate device analysis method and an analysis apparatus therefor may be provided.

In addition, according to the disclosure, a distribution of defects may be calculated in consideration of the shape of the device. Thus, the device may be easily and precisely analyzed.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A device analysis method comprising:
manufacturing a device;
supplying a first light signal to the device at a plurality of incident angles or a plurality of azimuth angles;
detecting a second light signal reflected from the device;
determining whether the device is normal or defective by analyzing the second light signal; and
when the device is a defective device, performing defect modeling on the defective device,
wherein the performing of the defect modeling comprises calculating a distribution of defects.

2. The device analysis method of claim 1, wherein the performing of the defect modeling is based on a shape of the device.

3. The device analysis method of claim 1, wherein the performing of the defect modeling is based on an intensity of the second light signal according to the plurality of incident angles or the plurality of azimuth angles.

4. The device analysis method of claim 1, wherein a cross section of the device includes a bottom portion extending in a horizontal direction and a side surface portion extending in a vertical direction perpendicular to the horizontal direction.

5. The device analysis method of claim 1, wherein the performing of the defect modeling includes separating the detected second light signal into a bottom portion component and a side surface portion component.

6. The device analysis method of claim 5, wherein a cross section of the device has a curved shape.

7. The device analysis method of claim 1, wherein a frequency of the second light signal is twice a frequency of the first light signal.

8. The device analysis method of claim 1, wherein the device includes at least one of a semiconductor device or a display device.

9. A device analysis method comprising:
manufacturing a device;
supplying a first light signal to the device at a plurality of incident angles or a plurality of azimuth angles;
detecting a second light signal reflected from the device;
determining whether the device is normal or defective by analyzing the second light signal; and
when the device is a defective device, performing defect modeling on the defective device,
wherein the performing of the defect modeling comprises
modeling a defect space distribution;
calculating an intensity of an electric field according to a model;
calculating an intensity of the second light signal based on the intensity of the electric field; and
comparing the second light signal reflected from the device with the second light signal calculated by performing defect modeling.

10. The device analysis method of claim 9, wherein the performing of the defect modeling includes predicting a position of a defect and a density of the defect based on a shape of the device.

11. The device analysis method of claim 9, wherein the intensity of the electric field is expressed as a function of an angle formed by an interface of the device and the electric field.

12. The device analysis method of claim 9, wherein the calculating of the intensity of the electric field according to the model is performed based on a direction of the electric field of an interface according to a position of a defect.

13. The device analysis method of claim 9, wherein when the second light signal reflected from the device and the second light signal calculated by performing defect modeling are same, a defect distribution of a defect model is selected as a defect distribution of the device.

14. The device analysis method of claim 9, wherein when the second light signal reflected from the device and the second light signal calculated by performing defect modeling are different, an additional defect space distribution is modeled.

15. The device analysis method of claim 9, wherein the determining of whether the device is normal or defective is performed based on the detected intensity of the second light signal.

16. A device analysis apparatus comprising:
a light source unit configured to generate and emit a first light signal;
a sample unit configured to receive the first light signal and reflect the first light signal as a second light signal;
a detection unit configured to detect the second light signal; and
an analysis unit configured to analyze the second light signal detected by the detection unit,
wherein the first light signal is configured to be incident on the sample unit at a plurality of incident angles or a plurality of azimuth angles, and
the analysis unit is configured to model a defect based on a shape of a device.

17. The device analysis apparatus of claim 16, wherein at least one of relative positions of the light source unit and the sample unit or relative positions of the sample unit and the detection unit are changed.

18. The device analysis apparatus of claim 16, wherein
the sample unit includes a stage configured to support the device, and
the stage is configured to tilt, translate, and rotate.

19. The device analysis apparatus of claim 16, wherein the analysis unit is configured to calculate a distribution of electric fields based on an intensity of the second light signal and model the defect based on the distribution of the electric fields.

20. The device analysis apparatus of claim 16, further comprising: a healing unit configured to heal a defective device and allow a third light signal to be incident on the defective device.
